(19) United States
(12) Patent Application Publication
(10) Pub. No.: US 2013/0011935 A1
(43) Pub. Date: Jan. 10, 2013

(54) METHOD OF MEASURING CHARACTERISTICS OF SPECIMEN AND SENSING DEVICE FOR USE WITH THE SAME

(75) Inventors: Koji Tanaka, Nagaokakyo-shi (JP); Seiji Kamba, Nagaokakyo-shi (JP); Takashi Kondo, Kyoto-fu (JP); Kazuhiro Takigawa, Nagaokakyo-shi (JP); Yoshiko Miura, Fukuoka-shi (JP)

(73) Assignee: Murata Manufacturing Co., Ltd., Nagaokakyo-shi (JP)

(21) Appl. No.: 13/616,805

(22) Filed: Sep. 14, 2012

Related U.S. Application Data
(63) Continuation of application No. PCT/JP2011/050963, filed on Jan. 20, 2011.

(30) Foreign Application Priority Data
Apr. 1, 2010 (JP) 2010-084981

(51) Int. Cl. G01N 21/35

(52) U.S. Cl. 436/501

(57) ABSTRACT

A method of measuring characteristics of a specimen, the measuring method including the steps of bonding the specimen to a host molecule on a sensing device, emitting an electromagnetic wave of a particular frequency to the sensing device to which the specimen is bonded, measuring a frequency characteristic of the transmitted or reflected light, and measuring the characteristics of the specimen based on a change of the frequency characteristic, wherein an absorbance of the host molecule per unit quantity at the particular frequency is smaller than that of the specimen.

### CROSS REFERENCE TO RELATED APPLICATIONS

The present application is a continuation of International application No. PCT/JP2011/050963, filed Jan. 20, 2011, which claims priority to Japanese Patent Application No. 2010-084981, filed Apr. 1, 2010, the entire contents of each of which are incorporated herein by reference.

### FIELD OF THE INVENTION

The present invention relates to a method of measuring a biological substance, such as a protein, with high sensitivity, and to a sensing device for use with the measuring method.

### BACKGROUND OF THE INVENTION

For analyzing characteristics of a substance, there has hitherto been employed a method of measuring characteristics of a specimen by holding the specimen on a particular sensing device, emitting an electromagnetic wave to the sensing device on which the specimen is held, and analyzing a frequency characteristic obtained with the electromagnetic wave.

Patent Document 1 (Japanese Unexamined Patent Application Publication No. 2004-45390) discloses a method of, without labeling any molecule in an analyte, analyzing a biological substance with high sensitivity in a very simple manner through the steps of causing the analyte to act on a molecular array that is prepared by fixating and arranging a probe molecule onto a substrate, scanning the molecular array by the microscopic Fourier transform infrared spectroscopy, and measuring and detecting absorption by a biological molecule in the analyte, which has been specifically bonded to the probe. Patent Document 1 states that high-sensitivity detection is enabled with, e.g., selection of a linker that is used in fixating the biological substance onto the substrate (see [0010], [0032] and FIG. 1 in Patent Document 1).

Because of containing functional groups such as an amide group (—NH—CO—), proteins absorb light of particular wavelengths specific to the functional groups (e.g., light of about 1500 to 1700 cm⁻¹ in the case of the amide group) (see [0038] in Patent Document 1). More specifically, Patent Document 1 states that, as a result of spotting a protein onto a gold substrate and measuring an FT-IR spectrum, an NH group portion of an amide group in the protein exhibits an absorption peak at 46 THz (46 THz corresponding to 1533 cm⁻¹) (see [0052] to [0054] and FIG. 9).

Patent Document 1 describes a method of fixating a protein to a molecular array by using an antibody that is fixated onto a gold substrate through a peptide bond (—NH—CO—), thereby analyzing the protein (see [0033] and FIG. 1 in Patent Document 1). The above-mentioned peptide bond and a peptide bond in the antibody have structures containing NH groups. Each of those NH groups exhibits specific light absorption similarly to the NH group contained in the specimen, e.g., protein. Therefore, a proportion of the light absorption caused by the others than the specimen is increased and an S/N ratio in the measurement is reduced. This leads to the problem of a reduction in detection sensitivity of the specimen. Patent Document 1 does not discuss the above-mentioned problem attributable to the light absorptions caused by the linker and the antibody, which are fixated to the substrate.
Patent Document 1: Japanese Unexamined Patent Application Publication No. 2004-45390

### SUMMARY OF THE INVENTION

An object of the present invention is to increase an S/N ratio by reducing noise and to increase sensitivity in measurement of a specimen in a method of measuring characteristics of the specimen by emitting an electromagnetic wave to a sensing device including a host molecule bondable to the specimen and a substrate onto which the host molecule is fixated, and analyzing a frequency characteristic obtained with the electromagnetic wave.

The present invention provides a method of measuring characteristics of a specimen, the measuring method comprising the steps of:

bonding, to a sensing device including a host molecule bondable to the specimen and a substrate onto which the host molecule is fixated, the specimen through the host molecule;

emitting an electromagnetic wave of a particular frequency to the sensing device to which the specimen is bonded, and measuring a frequency characteristic of the transmitted or reflected light; and

measuring the characteristics of the specimen based on change of the frequency characteristic.

The present invention further provides a sensing device for use with a method of measuring characteristics of a specimen, the measuring method comprising the steps of:

bonding, to the sensing device including a host molecule bondable to the specimen and a substrate onto which the host molecule is fixated, the specimen through the host molecule;

emitting an electromagnetic wave of a particular frequency to the sensing device to which the specimen is bonded, and measuring a frequency characteristic of the transmitted or reflected light; and

measuring the characteristics of the specimen based on change of the frequency characteristic,

wherein an absorbance of the host molecule per unit quantity at the particular frequency is smaller than that of the specimen.

The host molecule is preferably a molecule specifically bonded to the specimen.

Preferably, the specimen contains a functional group that exhibits a large absorbance with respect to the electromagnetic wave of the particular frequency, and the host molecule does not contain the functional group that exhibits a large absorbance with respect to the electromagnetic wave of the particular frequency.

The functional group that exhibits a large absorbance with respect to the electromagnetic wave of the particular frequency is an NH group.

The specimen is preferably a protein.

Preferably, the host molecule contains a sugar chain or a partial structure of a sugar chain, the sugar chain and the partial structure being specifically bonded to the specimen.

Preferably, an atomic number of the specimen is larger than an atomic number of the host molecule. Alternatively, molecular weight of the specimen is larger than molecular weight of the host molecule.

Preferably, a relative dielectric constant of the specimen at the particular frequency is larger than that of the host molecule. Alternatively, tan δ of the specimen is larger than tan δ of the host molecule.

The substrate is preferably made of a metal or a dielectric.

With the sensing device and the measuring method according to the present invention, since an absorption peak of the host molecule is different from that of the specimen (guest molecule), the change in a frequency characteristic corresponding to a characteristic change of the specimen can be detected without being substantially affected by variations attributable to the sensing device itself, e.g., the host molecule. As a result, measurement noise is reduced, and sensitivity and accuracy in the measurement of the specimen can be increased.

### BRIEF DESCRIPTION OF THE DRAWINGS

FIG. 1A is a structural formula of a host molecule fixated onto a substrate in EXAMPLE 1.

FIG. 1B is a structural formula of a host molecule fixated onto a substrate in COMPARATIVE EXAMPLE 1.

FIG. 2 illustrates frequency spectra of transmissivity, which are obtained with measurements in EXAMPLE 1 and COMPARATIVE EXAMPLE 1.

FIG. 3 illustrates absorption spectra obtained in EXAMPLE 2, when a thickness of a sugar chain layer is changed, in the case (a) where only a sugar chain layer not containing an NH group is used, and the case (b) where a protein is fixated to the sugar chain layer not containing an NH group.

FIG. 4 illustrates absorption spectra obtained in EXAMPLE 2, when a thickness of a sugar chain layer is changed, in the case (a) where only the sugar chain layer not containing an NH group is used, and the case (c) where a protein is fixated to a sugar chain layer containing an NH group.

FIG. 5 is a graph plotting a peak absorbance and a variation at a particular frequency in the case (b) in FIG. 3 where a sugar chain having tan δ of 0 at the particular frequency is used, and in the case (c) in FIG. 4 where a sugar chain having tan δ of 0.2 at the particular frequency is used.

FIG. 6A illustrates an absorption spectrum of a protein (ConA), which is obtained in EXAMPLE 3.

FIG. 6B illustrates an absorption spectrum of a sugar (galactose), which is obtained in EXAMPLE 3.

FIG. 7 illustrates absorption spectra obtained in EXAMPLE 4.

FIG. 8 illustrates, in enlarged scale, a frequency range of 30 to 60 THz in FIG. 7.

### DETAILED DESCRIPTION OF THE PREFERRED EMBODIMENTS

The present invention relates to a method of measuring a frequency characteristic when an electromagnetic wave of a particular frequency is emitted to a sensing device including a host molecule bondable to a specimen and a substrate onto which the host molecule is fixated, and measuring characteristics of the specimen based on change in the frequency characteristic. The present invention further relates to a sensing device for use with the measuring method. Here, the term “frequency characteristic” may be a frequency characteristic of an electromagnetic wave that has transmitted through the sensing device (i.e., a forward-scattered electromagnetic wave), or a frequency characteristic of an electromagnetic wave that has been reflected by the sensing device (i.e., a backward-scattered electromagnetic wave).

The sensing device of the present invention is featured in that the absorbance per unit quantity of the sensing device at a particular frequency used in measuring a specimen (simply referred to as “particular frequency”) is smaller than that of the specimen. Here, the term “particular frequency” usually implies a frequency of an electromagnetic wave that exhibits absorption specific to the specimen. The absorbance per unit quantity of the sensing device at the particular frequency is preferably 10% or less of that of the specimen at the particular frequency.

In the present invention, measuring characteristics of the specimen implies quantitative and various qualitative measurements, etc. of a compound as a specimen. For example, the measurements include the case of measuring the content of a trace specimen in a, e.g., solution, and the case of identifying a specimen. A more concrete example is a method of immersing the sensing device in a solution that contains a specimen, causing the specimen to be attached to a surface of the sensing device, washing out a solvent and the extra specimen, drying the sensing device, emitting an electromagnetic wave to the sensing device, and measuring characteristics of the specimen.

The sensing device of the present invention includes a host molecule bondable to a specimen and a substrate onto which the host molecule is fixated. Preferably, the sensing device is constituted by the host molecule bondable to the specimen and the substrate onto which the host molecule is fixated.

The substrate constituting the sensing device may be, for example, a plate-like member, a porous member such as a membrane film, a pore structure, or a vessel such as a well plate. The term “pore structure” implies a structure including many pores therein, such as a metal mesh film. While the material of the substrate is not limited to particular one, it preferably exhibits a small absorbance per unit quantity at the particular frequency. The reason is that the noise in the measurement of the specimen can be further reduced by selecting the material of the substrate, which exhibits a smaller absorbance per unit quantity at the particular frequency. In practice, the material of the substrate may be a metal such as Au, a semiconductor such as Si, a ceramic such as ZnSe, or an olefin-based resin such as polyethylene.

In the present invention, the specimen can be held on the sensing device by using suitable one of various known methods. For example, the specimen may be attached to the host molecule that is directly fixated to the sensing device, or may be attached to the host molecule that is fixated to a support film disposed in contact with the substrate. From the viewpoint of performing the measurement with higher reproducibility rather than increasing the measurement sensitivity and suppressing variations in the measurement, the specimen is preferably attached to the host molecule that is directly fixated to the surface of the sensing device.

The term “host molecule” implies a molecule enabling the specimen to be bonded thereto. The host molecule is preferably a molecule enabling the specimen to be specifically bonded thereto. Further, the host molecule preferably does not contain a functional group that exhibits a large absorbance per unit quantity at the particular frequency. The reason is as follows. Usually, the specimen contains a functional group that exhibits a large absorbance per unit quantity at the particular frequency. In that case, if the host molecule also contains the same functional group, the frequency characteristic attributable to the sensing device itself causes measurement noise.

More specifically, when the specimen is a protein, for example, the functional group exhibiting a large absorbance per unit quantity at the particular frequency is an NH group. In such a case, the host molecule of the sensing device is preferably a molecule not containing any NH groups (i.e., not containing even an NH group other than that attributable to the protein).

A combination of the host molecule and the specimen may be, for example, an antigen and an antibody, a sugar chain and a protein, a lipid and a protein, a low-molecular compound (ligand) and a protein, a protein and a protein, or a single strand DNA and a single strand DNA.

The host molecule containing a sugar chain specifically bondable to the specimen or a partial structure of a sugar chain (which is specifically bondable to the specimen through only the partial structure thereof) is preferably used in the present invention. There are sugars containing no NH groups and having properties enabling them to be specifically bonded to proteins. By selecting one of those sugars as the host molecule, it is possible to reduce the measurement noise caused when one of those proteins is measured as the specimen, and it is possible to perform the measurement with high sensitivity and high accuracy.

Further, the number of atoms per unit quantity of the specimen is preferably larger than that per unit quantity of the host molecule. More preferably, the former number of atoms is five or more times the latter (namely, the molecular weight is five times or more). Here, the term “unit quantity” implies, for example, one molecule or 1 mol of the specimen. A difference in the number of atoms between the specimen and the host molecule is also effective in reducing noise in the measurement of the specimen and in performing the measurement with high sensitivity and high accuracy.

At least a part of a surface of the substrate constituting the sensing device is preferably made of a conductor. Here, the term “conductor” implies an object (substance) allowing electricity to pass therethrough and includes not only a metal, but also a semiconductor. Examples of the metal include a metal bondable to a functional group of a compound, the functional group being, e.g., a hydroxy group, a thiol group, or a carboxyl group, a metal allowing a functional group, e.g., a hydroxy group or an amino group, to be coated on its surface, and alloys of those metals. Practical examples of those metals are gold, silver, copper, iron, nickel, chromium, silicon, and germanium. Preferably, gold, silver, copper, nickel, or chromium is used. More preferably, gold is used. Using gold or nickel is advantageous particularly when the specimen contains a thiol group (—SH group), because the thiol group can be bonded to the surface of the sensing device. Using nickel is advantageous particularly when the specimen contains a hydroxy group (—OH) or a carboxyl group (—COOH), because such a functional group can be bonded to the surface of the sensing device. Examples of the semiconductor include not only compound semiconductors including IV group semiconductors (such as Si and Ge), II-VI group semiconductors (such as ZnSe, CdS, and ZnO), III-V group semiconductors (such as GaAs, InP, and GaN), IV group compound semiconductors (such as SiC and SiGe), and I-III-VI group semiconductors (such as CuInSe₂), but also organic semiconductors.

When the specimen is attached to the host molecule that is fixated to, e.g., a support film, the attachment is performed, in one practical example, by pasting the support film made of, e.g., a polyamide resin to the surface of the sensing device, and by attaching the specimen to the host molecule that is fixated to the support film. When using the support film as an intermediate member, a material having a small absorbance per unit quantity at the particular frequency is preferably selected as the support film.

In the sensing device of the present invention, a portion of the substrate surface to which the host molecule is not bonded may be covered with a blocking agent. Covering such a portion with a blocking agent is a manner for directly avoiding the occurrence of non-specific adsorption of other substances than the specimen to the substrate.

The electromagnetic wave used in the present invention is not limited to particular one. One example of the electromagnetic wave is a terahertz wave. The particular frequency is preferably 20 GHz to 120 THz. When the specimen is a protein, the particular frequency is preferably about 36 to 51 THz (corresponding to a wavenumber of 1700 to 1200 cm⁻¹), which is an amide band frequency specific to the peptide bond of the protein. One practical example of the electromagnetic wave is a terahertz wave that is generated by using a short optical pulse laser as a light source, and by utilizing the optical rectification effect of an electro-optical crystal, e.g., ZnTe. Another example is a terahertz wave that is generated by using a short optical pulse laser as a light source, exciting free electrons in a photoconductive antenna, and by applying a voltage to the photoconductive antenna to momentarily produce a current.

### EXAMPLES

While the present invention will be described in more detail below in connection with EXAMPLES, it is to be noted that the present invention is not limited to the following EXAMPLES.

### Example 1

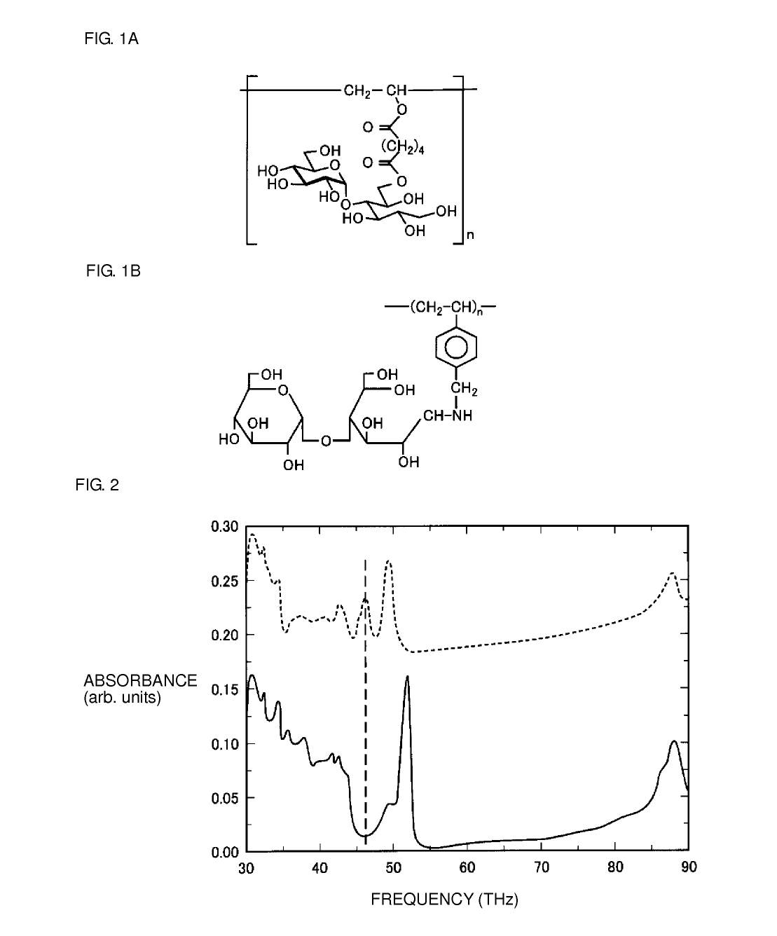

A sensing device was prepared by fixating, as a host molecule to which a specimen is to be specifically bonded, a compound expressed by a structural formula illustrated in FIG. 1A (in the formula, n is 5 to 15) and containing a sugar chain (but not containing an NH group) onto a glass substrate. The host molecule was fixated onto the glass substrate by first coating an aqueous solution of the host molecule over the glass substrate, and then air-drying the glass substrate at a room temperature.

For the sensing device thus prepared, an absorbance was measured and a frequency spectrum was obtained by using an FT-IR apparatus (made by Spectrum Co.).

### Comparative Example 1

As in EXAMPLE 1, a sensing device was prepared by fixating, as a host molecule (to which a specimen is to be specifically bonded), a compound expressed by a structural formula illustrated in FIG. 1B (in the formula, n is 7 to 8) and containing an NH group onto a glass substrate. For the sensing device thus prepared, an absorbance was measured and an absorption spectrum was obtained in a similar manner to that in EXAMPLE 1.

FIG. 2 illustrates the spectra obtained in EXAMPLE 1 and COMPARATIVE EXAMPLE 1. In FIG. 2, EXAMPLE 1 is denoted by a solid line, and COMPARATIVE EXAMPLE 1 is denoted by a dotted line. As seen from FIG. 2, near 46 THz at which the NH group exhibits specific absorption, a peak representing noise does not substantially appear in EXAMPLE 1, whereas a peak representing noise significantly appears in COMPARATIVE EXAMPLE 1. Although a measurement for a specimen attached to the sensing device is not performed in EXAMPLE 1 and COMPARATIVE EXAMPLE 1, it is positively expected that, when measurements are performed by attaching a specimen, e.g., a protein, to each of the sensing devices of EXAMPLE 1 and COMPARATIVE EXAMPLE 1, the protein in a smaller amount can be measured by using the sensing device of EXAMPLE 1 in comparison with the case using the sensing device of COMPARATIVE EXAMPLE 1. Furthermore, it is expected that, even when a protein amount is increased, reproducibility of the measurement is deteriorated in COMPARATIVE EXAMPLE 1 because the noise peak in COMPARATIVE EXAMPLE 1, illustrated in FIG. 2, causes a variation.

### Example 2

An absorption spectrum of an electromagnetic wave was obtained by executing simulated calculation on each of the following three models:

model of a sensing device in which only a sugar chain not containing an NH group is fixated onto the substrate,

model of the case fixating a protein to the sensing device in which only a sugar chain not containing an NH group is fixated onto the substrate, and

model of the case fixating a protein to a sensing device in which only a sugar chain containing an NH group is fixated onto the substrate.

In more detail, an absorption spectrum of an electromagnetic wave with a frequency of 0.90 to 1.05 THz was obtained by executing simulated calculation on each of the following three cases:

sensing device in the form of plate-like member made of a substance having the complex dielectric constant of ∈ᵣ=2.4 and tan δ=0 (the substance being assumed as a sugar chain not containing an NH group) and having a thickness of 15 μm,

sensing device obtained by laminating a layer, which is made a substance having a complex dielectric constant of ∈ᵣ=3 and tan δ=0.4 (the substance being assumed as a protein) and which has a thickness of 15 μm, on the surface of the same plate-like member as that in above (a),

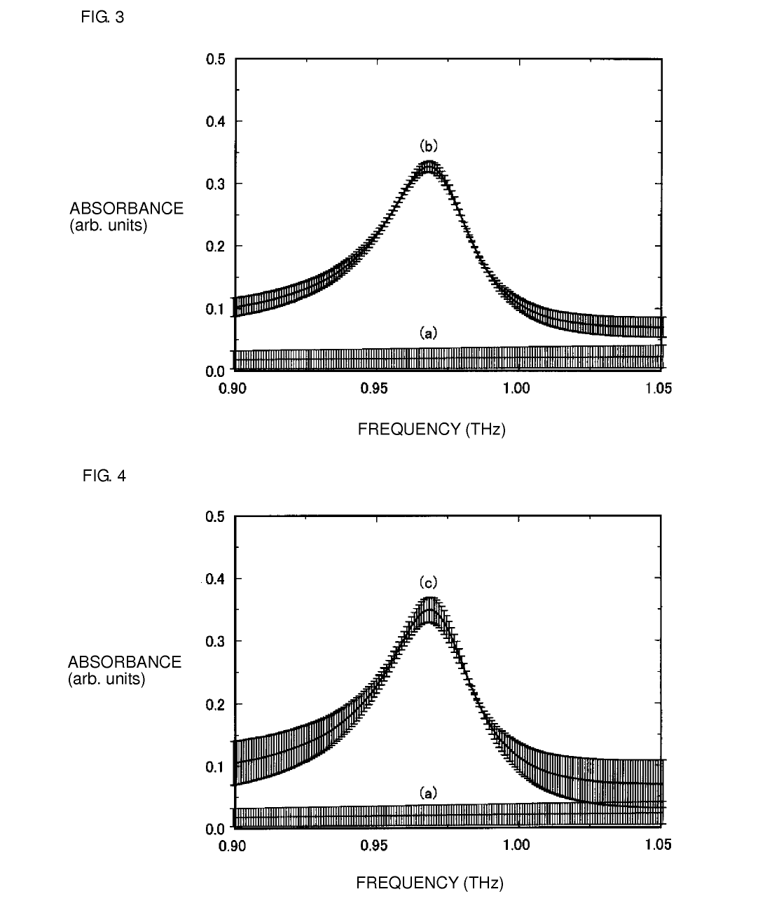

sensing device obtained by laminating the layer, which is made the substance having the complex dielectric constant of ∈ᵣ=3 and tan δ=0.4 (the substance being assumed as a protein) and which has a thickness of 15 μm, on the surface of a plate-like member made of a substance having ∈ᵣ=2.4 and tan δ=0.2 (the substance being assumed as a sugar chain containing an NH group) and having a thickness of 15 μm. The obtained absorption spectra are illustrated in FIGS. 3 and 4.

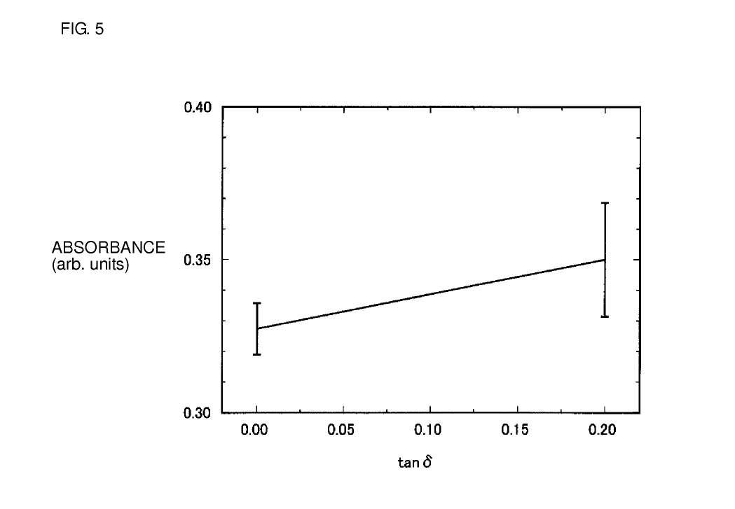

Moreover, in consideration of errors (variations in amount of the sugar chain fixated onto the substrate) which were generated in manufacturing of the individual sensing devices, variations in the absorbance were calculated for each of (a) to (c) on the cases where the thickness of the layer made of the sugar chain was changed to five different values (i.e., 5, 10, 15, 20 and 25 μm). The calculated variations are illustrated in FIGS. 3 and 4. As seen from the illustrated results, the variation in the absorbance is smaller when tan δ of the sugar chain is smaller (i.e., when the sugar chain does not contain an NH group, etc.), and the absorbance is less susceptible to an influence caused by the errors in manufacturing of the sensing device. In addition, FIG. 5 illustrates the relationship between the peak absorbance, including a variation thereof, at the particular frequency and tan δ of the sugar chain for the case (corresponding to (b) in FIG. 3) where the sugar chain having tan δ=0 at the particular frequency is used, and the case (corresponding to (c) in FIG. 4) where the sugar chain having tan δ=0.2 at the particular frequency is used. As seen from FIG. 5, the smaller tan δ of the sugar chain, the smaller is the variation in the absorbance.

While the above calculation is performed on condition that the thickness of the layer made of the sugar chain is set to 5 μm to 25 μm, the thickness of the layer made of the sugar chain in the actual sensing device is a thickness of a one-molecular layer and is several nm.

### Example 3

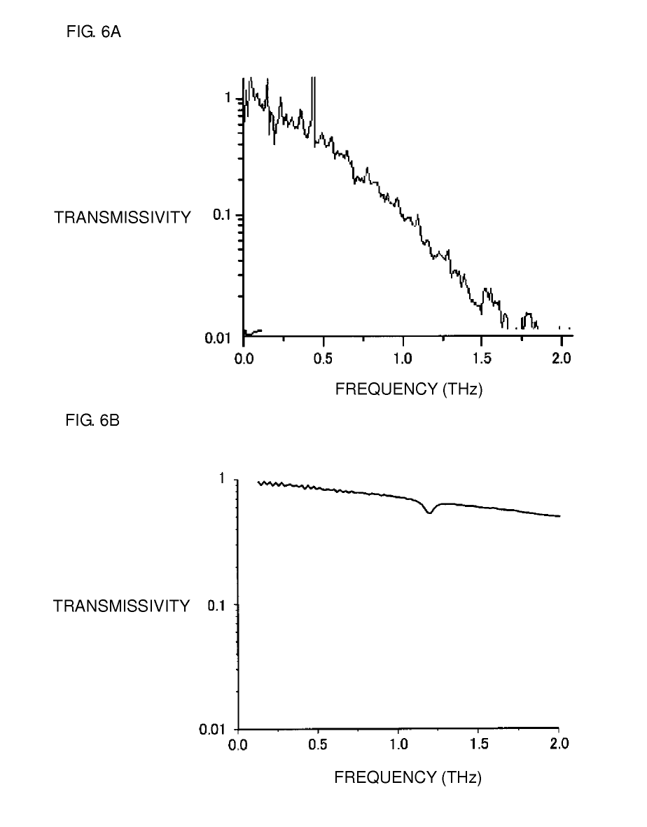

A transmissivity spectrum was compared between a protein (ConA: concanavalin A) as a specimen having a large atomic number (having high molecular weight) and a sugar chain (galactose) as a host molecule having a small atomic number (having low molecular weight). The transmissivity spectrum was obtained by preparing pellet-like samples made of respectively ConA and galactose and having a thickness of 1 mm, and by measuring transmissivity for each of the samples with a THz-TDS (terahertz time domain spectroscopic apparatus). FIG. 6A illustrates the transmissivity spectrum of the ConA, and FIG. 6B illustrates the transmissivity spectrum of the galactose.

As plotted in FIGS. 6A and 6B, in the range of 1.5 to 2.0 THz, for example, a large difference appears in the transmissivity (absorbance) between the two samples. It is hence understood that noise in the measurement of the specimen can be reduced by setting the atomic number (molecular weight) of the specimen to be different from the atomic number (molecular weight) of the host molecule that is fixated to the sensing device.

### Example 4

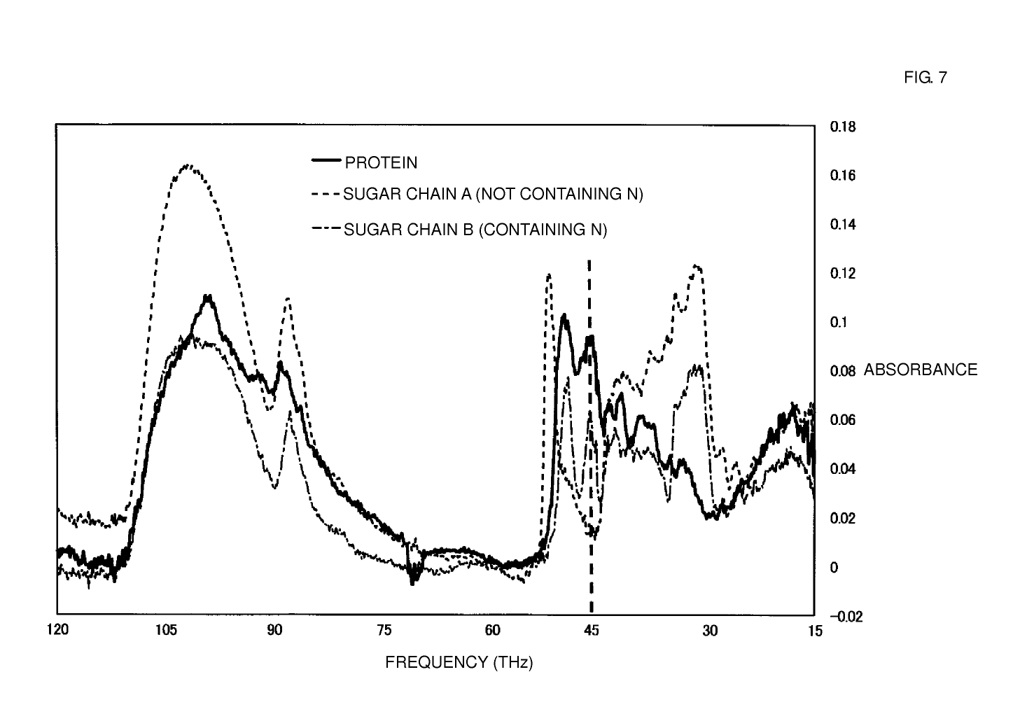

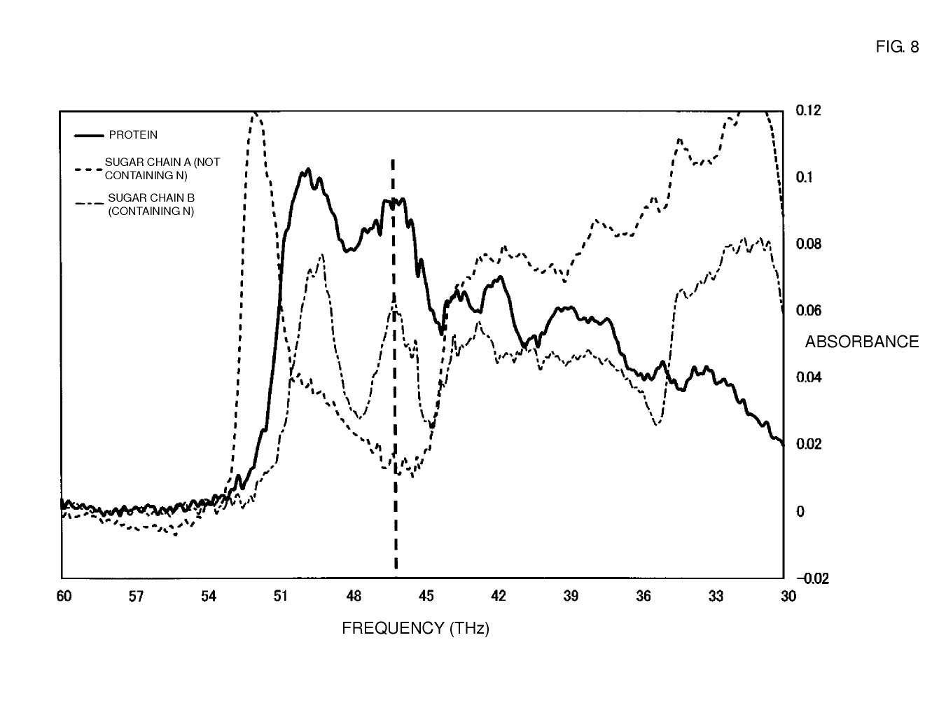

Samples were each prepared by directly fixating a protein (ConA), a sugar chain A (i.e., a sugar chain not containing an NH group, illustrated in FIG. 1A), or a sugar chain B (i.e., a sugar chain containing an NH group, illustrated in FIG. 1B) to a substrate (plate-like member made of glass and having a thickness of 0.3 mm), and the absorbance of each sample per 100 μg was measured by using an FT-IR (Fourier transform infrared spectrophotometer). FIG. 7 plots absorption spectra obtained with the measurement. Furthermore, FIG. 8 plots, in enlarged scale, a frequency range of 30 to 60 THz in FIG. 7.

As seen from FIGS. 7 and 8, in the absorption spectrum of the protein, there is an absorbance peak near 46 THz that is an absorption peak of the NH group. In the absorption spectrum of the sugar chain A (i.e., the sugar chain not containing an NH group), an absorbance peak does not appear at the same position as that of the NH group. It is hence understood that noise in the measurement of the protein can be reduced by using the sensing device in which the host molecule not containing the NH group is fixated to the substrate. On the other hand, in the absorption spectrum of the sugar chain B (i.e., the sugar chain containing an NH group), there is an absorbance peak at the same position as that of the protein. It is hence thought that the sugar chain B causes noise in the measurement of the protein.

The embodiment and EXAMPLES disclosed herein are to be considered in all respects as illustrative and not restrictive. The scope of the present invention is defined in Claims instead of the above description, and it is purported to involve all modifications corresponding to equivalents of the matters defined in Claims and falling within the scope of Claims.

1. A method of measuring characteristics of a specimen, the method comprising:
bonding the specimen to a host molecule, the host molecule being bonded to a sensing device;
emitting an electromagnetic wave of a particular frequency to the sensing device having the specimen;
measuring a frequency characteristic of transmitted or reflected light from the sensing device; and
measuring characteristics of the specimen based on a change of the frequency characteristic,
wherein an absorbance of the host molecule per unit quantity at the particular frequency is smaller than that of the specimen.

2. The method according to claim 1, wherein the host molecule is a molecule specifically bonded to the specimen.

3. The method according to claim 1, wherein the specimen contains a functional group that exhibits a greater absorbance with respect to the electromagnetic wave of the particular frequency than the host molecule.

4. The method according to claim 3, wherein the functional group is an NH group.

5. The method according to claim 4, wherein the specimen is a protein.

6. The method according to claim 5, wherein the host molecule contains a sugar chain or a partial structure of a sugar chain, the sugar chain and the partial structure being bonded to the specimen.

7. The method according to claim 1, wherein an atomic number of the specimen is larger than an atomic number of the host molecule.

8. The method according to claim 1, wherein molecular weight of the specimen is larger than molecular weight of the host molecule.

9. The method according to claim 1, wherein a relative dielectric constant of the specimen at the particular frequency is larger than that of the host molecule.

10. The method according to claim 1, wherein tan δ of the specimen is larger than tan δ of the host molecule.

11. The method according to claim 1, wherein the substrate is made of a metal or a dielectric.

12. The method according to claim 1, further comprising covering at least a portion of the sensing device not having the host molecule with a blocking agent.

13. The method according to claim 1, wherein the electromagnetic wave is a terahertz wave.

14. The method according to claim 1, wherein the particular frequency is 20 GHz to 120 THz.
